(19) United States
(12) Patent Application Publication
(10) Pub. No.: US 2015/0302597 A1
(43) Pub. Date: Oct. 22, 2015

(54) SYSTEMS AND METHODS FOR PREPARING CUSTOM CLOTHING PATTERNS

(71) Applicant: Avyn, Inc., Austin, TX (US)

(72) Inventor: Aimee Bentson, Plano, TX (US)

(21) Appl. No.: 14/672,161

(22) Filed: Mar. 28, 2015

Related U.S. Application Data
(60) Provisional application No. 61/981,508, filed on Apr. 18, 2014.

(51) Int. Cl. G06T 7/00; G06K 9/00

(52) U.S. Cl. CPC G06T 7/0075; G06K 9/00369; G06K 9/00221; G06T 2207/10012; G06T 2207/30196

(57) ABSTRACT

Methods and systems of preparing custom clothing patterns are described. In particular, custom clothing patterns are prepared by obtaining a 3-D image of an individual, determining points of measurements of the individual from the 3-D image, and modulating a digital clothing pattern template comprising measurement locations corresponding to the points of measurements by applying the measurements to the corresponding measurement locations of the digital pattern template, and altering the pattern based on the measurements.

The present application claims the benefit of U.S. Provisional Application Ser. No. 61/981,508, entitled “SYSTEMS AND METHODS FOR PREPARING CUSTOM CLOTHING PATTERNS”, filed Apr. 18, 2014, which is incorporated herein by reference.

### BACKGROUND

Properly fitting clothing is hard to find at a reasonable cost. Most affordable clothing is off-the-rack or ready-to-wear, meaning that most clothes are sized to fit the average of a group rather specifically tailored to each person. As such, most ready-to-wear clothing fits poorly. On the other hand, clothes specifically tailored for a person (such as made-to-measure clothing) require the time and attention of a tailor, and are therefore more expensive and less desirable to most people.

One approach for obtaining made-to-measure clothing without requiring a tailor, and therefore at a cheaper cost, is for a person to have their body measured by a body scan, which has been recently possible with the advent of new technology. However, while body scanning technology permits precise measurements and can offer a three-dimensional image of the person's body, it predominantly relies on generic avatars that resemble mannequins and lack any distinctive human qualities, let alone reflect the appearance of the consumer, or the person for whom the clothes are being purchased. Consequently, not only is there a lack of realism that creates an emotional distance that prevents a full “buy in” with the purchaser, but the purchaser is also unable to gain a realistic feel for how the garment will look specifically on them. The lack of a buy-in and accurate appreciation for how the clothes will look on the purchaser lead to fewer repeat purchases and may even increase product returns by dissatisfied customers.

### SUMMARY

The disclosure is directed to methods and systems of preparing custom clothing patterns in accordance with some embodiments of the invention. In particular, the disclosure is directed to obtaining a 3-D image of an individual, determining points of measurements of the individual from the 3-D image, and modulating a digital clothing pattern template comprising measurement locations corresponding to the points of measurements by applying the measurements to the corresponding measurement locations of the digital pattern template and altering the pattern based on the measurements.

In some embodiments the method comprises the step of refining the altered pattern by the individual.

In some embodiments the method comprises the step of refining by the individual selecting a predetermined fit.

In some embodiments the 3-D image or refined pattern, or both, is stored on a remote server.

In some embodiments the 3-D image comprises acquiring a detailed surface scan of the individual's face.

In some embodiments the detailed surface scan of the individual's face is colorized.

In some embodiments modulating of the digital clothing pattern template is performed automatically without user input.

In some embodiments the 3-D image is obtained by a body scanner or mobile device.

In some embodiments, the 3-d image is generated by an imaging device and provided to a user's computer. In some embodiments, the computer comprises a personal computer or mobile device.

In some embodiments, the 3-D image is obtained by one or more body scanners.

The disclosure is also directed to an electronic device where a method for viewing clothing on a 3-d image of an individual is performed. The method includes selecting a 3-D image of an individual that is associated with measurements of the individual; selecting an image of a piece of clothing to apply to the 3-D image where the clothing is associated with a pattern comprising a corresponding number of measurement locations; assigning the measurements from the individual to the corresponding measurement locations; re-sizing the image of the piece of clothing relative to the measurements of the individual; and overlaying the image of the re-sized piece of clothing onto the 3-d image of the individual.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a flow diagram of an exemplary but not exclusive method for preparing custom clothing patterns practiced in accordance with some embodiments of the invention; and

FIG. 2 is a block diagram of an illustrative electronic device for previewing application of beauty cosmetics in accordance with some embodiments of the invention.

### DETAILED DESCRIPTION

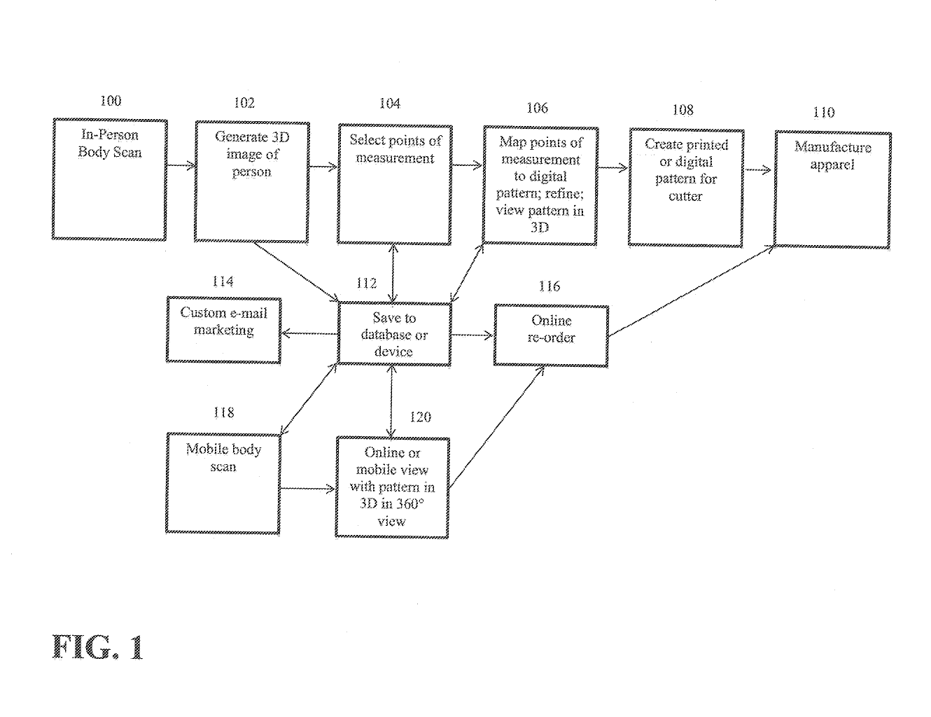

FIG. 1 is a flow diagram of an exemplary but not exclusive method for preparing custom clothing patterns practiced in accordance with some embodiments of the invention.

At step 100 in FIG. 1, an individual wanting to order customized, made-to-measure clothing begins by having their body scanned using one or more body scanners. The body scanner(s) scans the surface of the user's body to identify a series of points to form a three-dimensional image (3D image). As used herein, “three-dimensional image” or “3D image” refers to the creation of a 3D image from points identified during the scan and does not include compiled two-dimensional images. Body scanners are generally known in the art and include white light and laser based scanners (e.g. body scanners utilizing Kinect technology), and additional modes of body scanning are also useful, including Wii and similar technology, mobile phone using multiple cameras from different angles, etc., or other methods of obtaining a highly accurate fully body image of the individual. In one embodiment, the scanning process is performed at a place of business or outside of the home. In another embodiment the user does not need to wear specialized clothing (e.g., a bodysuit) for the purpose of the scan. In fact, the individual may simply wear form-fitting clothing or be unclothed. In another embodiment, the scanning process is performed by the user where a 3D image is generated by an imaging device and provided to a user's computer. The computer includes any suitable platform such as a personal computer, laptop computer, tablets, personal digital assistant, smartphone, etc. The computer includes a processor accessing one or more tangible non-transitory computer media such as solid state storage and/or disk-based storage to undertake logic in accordance with present principles. The processor outputs visual images on a display and receives user input from one or more input device such as keypads, keyboards, point-and-click devices, etc. The computer can communicate using a network interface such as wired or wireless modem with the internet and specifically with one or more remote servers such as clothing provider servers having server processors accessing a server storage medium on which is stored clothing pattern images and logic in accordance with present principles.

At step 102, a three-dimensional (3D) image of the individual's body shape and relative size is created from the data acquired by the one or more body scanners of step 100. The data may be processed by the body scanner(s) itself or the data may be communicated and saved to a database 112 (e.g., locally or cloud-based) or device (e.g., a mobile device) for processing and creation of the 3D image. In one embodiment the body scanner or other device provides a higher resolution image of the individual's face. The higher resolution image may be by surface scan that accurately represents the individual's face and that may be colorized in further or concurrent image processing. For instance, in some embodiments it may be preferable to have a digital photograph of the face and exposed areas created and substituted for the data produced by the body scanner(s) to form a modified 3D image. The higher resolution further conveys a more realistic and personalized 3D body image to assist the individual in choosing a clothing style and fit more suitable to their overall visual appearance.

At step 104, points of measurement are extracted from the 3D image for creating a clothing pattern. In some embodiments the measurements are from a plurality of predetermined body points. In some embodiments, the predetermined body points comprise at least 10, 20, 30, 40, 50, 60, 70, 80, 90, 100, or more points on the individual's body. The measurements include but are not limited to height, neck circumference, width across the shoulders, the width across the shoulder blades, the width across the chest, chest circumference, the waist circumference, the hip circumference, the sleeve length, the seat, the rise, the hip, the thighs, and the wrist. Through software or hardware operable by the body scanner calculates the distances and the resulting measurements are representative of the physical size and shape of the individual's body parts to be clothed.

At step 106, the points of measurement are next mapped to one or more digital clothing patterns corresponding to the calculated measurements. In one embodiment the measurements are automatically mapped to corresponding locations on a clothing template resulting in customized patterns specific to the individual's measurements. In another embodiment measurements are automatically mapped to corresponding locations on a clothing template resulting in customized patterns specific to the individual's measurements and do not require manual input of measurements, and may not permit manually inputting measurements. Therefore, the points of measurement may be mapped to one or more digital clothing patterns corresponding to the calculated measurements through non-manual or manual input of measurements.

Clothing templates are preferably stored on database or device 112. The individual can view the appearance of the pattern on the individual's 3D image to evaluate its fit and save the 3D image with select patterns and styles to the database or device. It should be noted that by saving the information to the database or device permits more rapid future order processing such as by online re-orders in step 116.

The individual may further customize, refine and personalize the digital pattern. With the overlaid customized clothing pattern upon the body image, the individual can select a fit based on known or established clothing styles as a base for further customization by the individual. For instance, the predetermined fits could include snug, form-fitting, blousy, slim fit, European fit, American fit, and further refinements like short cuffs, pleats, garment length, sleeve length, etc. Upon selecting a predetermined fit, the pattern may be modified without requiring correction of body point measurements, thereby preserving all 3D image data for future use, particularly if stored remotely. In this regard the individual may find that additional points of measurement beyond those initially selected in step 104 provide a more suitable fit. The individual may therefore select additional points of measurement for refining the pattern and customizing the desired fit and style such as dragging a measurement point graphically represented on a GUI to the desired location or by moving a slidable button on a scale to correspondingly adjust the location of a point of measurement. In combination with the above embodiments, or alternatively, manually inputting measurement data by keyboard is not required or desired. The individual may also save the initial pattern and any additional customized digital pattern to the database or device for future reference and use. This is particularly helpful where the individual multiple personal 3D images such as before and after weight gain. If the individual does not wish to have a new 3D body scan performed, he may simply go to the saved image and order a garment based on the saved fit and/or style, or further customize the saved pattern before ordering the garment. Moreover, storage on a remote server permits an individual to return without having to go through the body scanning and customization process again. Where the remote server is operated by a third party, for example, a clothier, it also permits third parties (spouses, assistants, friends, relatives, gift givers, and the like) to order custom, made-to-measure clothing for the individual without needing to know the individual's measurements.

In some embodiments, any information acquired from the body scan, or input or modified by the individual in customizing and selecting a desired fit or style, could potentially be used in direct consumer advertising as indicated by step 114 (identified as email marketing, although other forms of marketing such as mail or website when accessed by the individual are also contemplated).

At step 108, after the individual has completed customization of the digital pattern and is satisfied with the pattern on the individual's 3D image, the pattern is ready to be sent to a digital cutting machine or printed for cutting of the final pattern for manufacturing, i.e., assembly of the pattern piece or pieces into wearable apparel or accessories. Digital cutting machines suitable for this step include but are not limited to the Gerber Z1, DCS 1500, DCS 2500, Taurus II Leather Cutter, Paragon, GTxL, XLc7000 and Z7. In some embodiments, the cutting machine is capable of automated creation of custom-fitted apparel patterns in response to the transmitted data.

Automatically generated custom patterns are sent in digital form to be cut and then used as part of an efficient mass customization process. Many aspects of garment construction can be automated.

After the patterns are cut, they are ready to be assembled according to step 110. While assembly is preferably performed by a professional (i.e., tailor or seamstress), anyone, including the individual, may assemble the pieces. As such, it is contemplated that manufacture of step 110 comprises sending the pieces from the site of cutting to the professional's or individual's place of business or home for assembly.

At step 118, instead of having to travel to facility for an in-person body scan identified in step 100, an individual can instead have a highly personalized 3D body scan performed by an application on their mobile device.

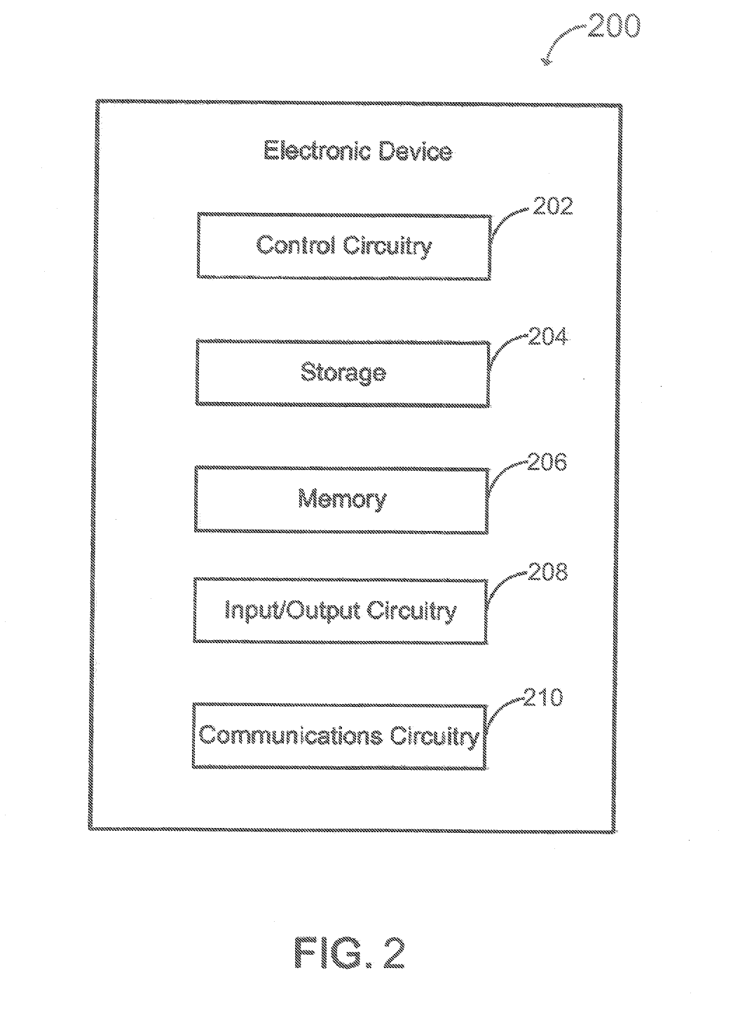

FIG. 2 is a block diagram of an illustrative but not limiting electronic device for performing an application operative for creating a 3D body scan and previewing application of apparel and accessories in accordance with some embodiments of the invention. Electronic device 200 can include control circuitry 202, storage 204, memory 206, input/output (“I/O”) circuitry 208, and communications circuitry 210. In some embodiments, one or more of the components of electronic device 200 can be combined or omitted (e.g., storage 204 and memory 206 may be combined). In some embodiments, electronic device 200 can include other components not combined or included in those shown in FIG. 2 (e.g., motion detection components, a power supply such as a battery or kinetics, a display, bus, a positioning system, a camera, an input mechanism, etc.), or several instances of the components shown in FIG. 2. For the sake of simplicity, only one of each of the components is shown in FIG. 2.

Electronic device 200 can include any suitable type of electronic device. For example, electronic device 200 can include a portable electronic device that the user may hold in his or her hand, such as a smartphone (e.g., an iPhone made available by Apple Inc. of Cupertino, Calif. or an Android device such as those produced and sold by Samsung). As another example, electronic device 200 can include a larger portable electronic device, such as a tablet or laptop computer. As yet another example, electronic device 200 can include a substantially fixed electronic device, such as a desktop computer.

Control circuitry 202 can include any processing circuitry or processor operative to control the operations and performance of electronic device 200. For example, control circuitry 202 can be used to run operating system applications, firmware applications, media playback applications, media editing applications, or any other application. In some embodiments, control circuitry 202 can drive a display and process inputs received from a user interface.

Storage 204 can include, for example, one or more storage mediums including a hard-drive, solid state drive, flash memory, permanent memory such as ROM, any other suitable type of storage component, or any combination thereof. Storage 204 can store, for example, media data (e.g., music and video files), application data (e.g., for implementing functions on electronic device 200), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that can enable electronic device 200 to establish a wireless connection), subscription information data (e.g., information that keeps track of podcasts or television shows or other media a user subscribes to), contact information data (e.g., telephone numbers and email addresses), calendar information data, and any other suitable data or any combination thereof

Memory 206 can include cache memory, semi-permanent memory such as RAM, and/or one or more different types of memory used for temporarily storing data. In some embodiments, memory 206 can also be used for storing data used to operate electronic device applications, or any other type of data that can be stored in storage 204. In some embodiments, memory 206 and storage 204 can be combined as a single storage medium.

I/O circuitry 208 can be operative to convert (and encode/decode, if necessary) analog signals and other signals into digital data. In some embodiments, I/O circuitry 208 can also convert digital data into any other type of signal, and vice-versa. For example, I/O circuitry 208 can receive and convert physical contact inputs (e.g., from a multi-touch screen), physical movements (e.g., from a mouse or sensor), analog audio signals (e.g., from a microphone), or any other input. The digital data can be provided to and received from control circuitry 202, storage 204, memory 206, or any other component of electronic device 200. Although I/O circuitry 208 is illustrated in FIG. 2 as a single component of electronic device 200, several instances of I/O circuitry 208 can be included in electronic device 200.

Electronic device 200 can include any suitable interface or component for allowing a user to provide inputs to I/O circuitry 208. For example, electronic device 200 can include any suitable input mechanism, such as for example, a button, keypad, dial, a click wheel, or a touch screen. In some embodiments, electronic device 200 can include a capacitive sensing mechanism, or a multi-touch capacitive sensing mechanism.

In some embodiments, electronic device 200 can include specialized output circuitry associated with output devices such as, for example, one or more audio outputs. The audio output can include one or more speakers (e.g., mono or stereo speakers) built into electronic device 200, or an audio component that is remotely coupled to electronic device 200 (e.g., a headset, headphones or earbuds that can be coupled to communications device with a wire or wirelessly).

In some embodiments, I/O circuitry 208 can include display circuitry (e.g., a screen or projection system) for providing a display visible to the user. For example, the display circuitry can include a screen (e.g., an LCD screen) that is incorporated in electronics device 200. As another example, the display circuitry can include a movable display or a projecting system for providing a display of content on a surface remote from electronic device 200 (e.g., a video projector). In some embodiments, the display circuitry can include a coder/decoder (CODEC) to convert digital media data into analog signals. For example, the display circuitry (or other appropriate circuitry within electronic device 200) can include video CODECs, audio CODECs, or any other suitable type of CODEC.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 202. Alternatively, the display circuitry can be operative to provide instructions to a remote display.

Communications circuitry 210 can include any suitable communications circuitry operative to connect to a communications network and to transmit communications (e.g., voice or data) from electronic device 200 to other devices within the communications network. Communications circuitry 210 can be operative to interface with the communications network using any suitable communications protocol such as, for example, Wi-Fi (e.g., a 802.11 protocol), Bluetooth., radio frequency systems (e.g., 900 MHz, 1.4 GHz, and 5.6 GHz communication systems), infrared, GSM, GSM plus EDGE, CDMA, LTE and other cellular protocols, VOIP, or any other suitable protocol.

In some embodiments, communications circuitry 210 can be operative to create a communications network using any suitable communications protocol. For example, communications circuitry 210 can create a short-range communications network using a short-range communications protocol to connect to other devices. For example, communications circuitry 210 can be operative to create a local communications network using the Bluetooth protocol to couple electronic device 200 with a Bluetooth headset.

Electronic device 200 can include one more instances of communications circuitry 210 for simultaneously performing several communications operations using different communications networks, although only one is shown in FIG. 2 to avoid overcomplicating the drawing. For example, electronic device 200 can include a first instance of communications circuitry 210 for communicating over a cellular network, and a second instance of communications circuitry 210 for communicating over Wi-Fi or using Bluetooth. In some embodiments, the same instance of communications circuitry 210 can be operative to provide for communications over several communications networks.

In some embodiments, electronic device 200 can be coupled a host device for data transfers, synching the communications device, software or firmware updates, providing performance information to a remote source (e.g., providing riding characteristics to a remote server) or performing any other suitable operation that can require electronic device 200 to be coupled to a host device. Several electronic devices 200 can be coupled to a single host device using the host device as a server. Alternatively or additionally, electronic device 200 can be coupled to several host devices (e.g., for each of the plurality of the host devices to serve as a backup for data stored in electronic device 200).

At step 118, as mentioned above, in some embodiments an electronic device (e.g., electronic device 100 of FIG. 2) may include an integrated application operative to perform a highly accurate 3D body scan of the individual.

At step 120, the integrated application is operative to allow the individual to select a 3D image of the individual, select an article of clothing to view, alter the image of the article of clothing (i.e, the digital pattern) to fit the predetermined points of measurement and any additional points of measurement selected by the user, and applying or overlaying the article of clothing to the individual's 3D image so that the individual may evaluate the fit. Thus, the integrated application permits the individual to perform steps 102, 104, 106, 108 of FIG. 1 as described above. The application may also permit the “clothed” 3D image to rotate in 360° view for more thorough evaluation by the individual.

In some embodiments, an electronic device (e.g., electronic device 100 of FIG. 2) may include an integrated application operative to interface with a database or another device having stored thereon an individual's 3D image and customized/refined points of measurement and selected clothing patterns that are viewable on the electronic device, which is in turn able to execute an online order via control circuitry 210 as noted by step 116 of FIG. 1. The integrated application permits the selection of one or more 3D images of the individual for viewing, selecting and ordering of clothing patterns.

The processes discussed above are intended to be illustrative and not limiting. Persons skilled in the art will appreciate that steps of the process discussed herein can be omitted, modified, combined, or rearranged, and any additional steps can be performed without departing from the scope of the invention.

The application can be implemented by software, but can also be implemented in hardware or a combination of hardware and software. The invention can also be embodied as computer-readable code on a computer-readable medium. The computer-readable medium can include any data storage device that can store data which can thereafter be read by a computer system. Examples of the computer readable medium include read-only memory (“ROM”), random-access memory (“RAM”), CD-ROMs, DVDs, magnetic tape, optical data storage device, flash storage devices, or any other suitable storage devices. The computer-readable medium can also be distributed over network coupled computer systems.

Insubstantial changes from the claimed subject matter as viewed by a person with ordinary skill in the art, now known or later devised, are expressly contemplated as being equivalently within the scope of this disclosure. Therefore, obvious substitutions now or later known to one with ordinary skill in the art are defined to be within the scope of the defined elements.

The above-described embodiments of the present invention are presented for purposes of illustration and not of limitation.

What is claimed is:

1. A method of preparing custom clothing patterns comprising:
obtaining a 3-d image of an individual;
determining at least 10 measurements of said individual from said 3-d image; and
modulating a digital clothing pattern template comprising measurement locations corresponding to said at least 10 measurements, said modulating comprising applying said measurements to the corresponding measurement locations of said digital pattern template and altering the pattern based on said at least 10 measurements.

2. The method of claim 1, further comprising the step of refining the altered pattern by the individual.

3. The method of claim 2, wherein the step of refining comprises the individual selecting a predetermined fit.

4. The method of claim 1 or 2, wherein the 3D image or refined pattern, or both, is stored on a remote server or mobile device.

5. The method of claim 1, wherein the step of obtaining a 3D image comprises acquiring a detailed surface scan of the individual's face.

6. The method of claim 5, wherein the detailed surface scan is colorized.

7. The method of claim 1, wherein the step of modulating is executed automatically without user input.

8. The method of claim 1, wherein the step of obtaining a 3D image is effected by body scanner or mobile device.

9. The method of claim 1, wherein a 3-d image is generated by an imaging device and provided to a user's computer.

10. The method of claim 9, wherein the computer comprises a personal computer or mobile device.

11. On an electronic device, a method for viewing clothing on a 3-d image of a user said method comprising:
selecting a 3-d image of an individual, said image associated with at least 10 measurements of said individual;
selecting an image of a piece of clothing to apply to said 3-d image, said clothing associated with a pattern comprising at least 10 measurement locations;
assigning said measurements from said individual to the corresponding measurement locations;
re-sizing the image of said piece of clothing relative to the measurements of said individual; and
overlaying the image of the re-sized piece of clothing onto the 3-d image of said individual.
